(19) United States
(12) Patent Application Publication
(10) Pub. No.: US 2009/0305779 A1
(43) Pub. Date: Dec. 10, 2009

(54) GAMING SYSTEM HAVING A DICE-BASED GAME WITH A PLURALITY OF WAGER AREAS

(75) Inventors: Mark Nicely, Daly City, CA (US); Paul Miltenberger, Las Vegas, NV (US)

Correspondence Address: K&L Gates LLP, P.O. Box 1135, CHICAGO, IL, 60690, US

(73) Assignee: IGT, Reno, NV (US)

(21) Appl. No.: 12/435,077

(22) Filed: May 4, 2009

Related U.S. Application Data
(62) Division of application No. 11/064,314, filed on Feb. 23, 2005, now Pat. No. 7,533,885.
(60) Provisional application No. 60/547,643, filed on Feb. 23, 2004.

(51) Int. Cl. A63F 13/00; A63F 9/24

(52) U.S. Cl. 463/30; 463/43; 463/25

(57) ABSTRACT

A gaming system and method involving a dice game. The gaming system displays a plurality of wager areas. Each wager area is associated with a wager area value. The gaming system indicates a plurality of different reward ratios associated with the wager areas. One or more of the wager areas are selectable by the player for wagering. A plurality of dice are simulated as rolled. If the sum of the stopped dice is equal to the value of any of the wagered upon areas, the gaming system provides an award. If a bonus condition is satisfied, the gaming system provides a bonus outcome.

### PRIORITY CLAIM

This application is a divisional of, and claims priority to, U.S. patent application Ser. No. 11/064,314 filed on Feb. 23, 2005, which claims priority to U.S. Provisional Patent Application Ser. No. 60/547,643 filed on Feb. 23, 2004, and the entire contents of such applications are hereby incorporated herein by reference.

### BACKGROUND

The present invention relates to the field of betting games having multiple events and permitting of multiple bets. Specifically, the present invention is an improved method for conducting such a betting game, wherein a bonus reward occurs which pays against underlying game bets, triggered by specified outcome events or by an event independent of the underlying game. In one embodiment, the bonus reward is resolved within the play of the underlying game of chance.

Slot games and other games of chance have experienced significant increases in their popularity and they profitability. Much of this new interest may be credited to a wealth of improvements, including in particular the addition of bonus events and bonus rewards. Such additions exhibit additional ways for the player to win, and so increase the interest in, and excitement of, the game. Despite generally seeing no improvement in their expectation of win, all but the most experienced player are likely to find the extra excitement sufficient justification for additional play.

Such bonus potential may add new elements of interest to multi-outcome/multibet games like roulette, money wheel, dice sum, and simulated racing. A multi-outcome/multi-bet game is herein defined as a game which may produce multiple game outcomes and which offers the player the ability to place bets on these several outcomes. Traditionally, the player must bet on a particular outcome in order to receive any reward for that outcome. Herein we add an improvement which can allow all bets to justify a bonus reward.

The traditional game of roulette consists of a horizontally aligned wheel divided into equal sized sectors, typically referred to as canoes, each said canoe being assigned a non-unique color and a unique number. Typically, the colors available are Red, Black, and Green, and numbers range from 1 to 36, augmented by 0 and 00, although the 00 designation is not universally used. Typically, roulette when played in Europe only utilizes a 0 designation, not a 00.

A round of play commences when, after the players have placed their bets, the house dealer spins the roulette wheel, and subsequently releases a ball into the spinning wheel. The ball eventually comes to rest in one of the canoes on the wheel. The designators assigned to the canoe in which the ball came to rest determine the several outcomes of the game. Such designators consist of the number associated with the canoe, the color, and the odd-of-even attribute. Note: 0 and 00 are not considered either odd or even numbers.

Players may bet on any or all of the result characteristics, the specific number, the color, or the odd/even characteristic. Number bets may be placed on individual numbers, or predefined groups of numbers. Game bets allow betting on 1, 2, 3, 4, 5, 6, 12, or 18 numbers. The larger the group on which the bet is placed, the lower the payout associated. Thus, a bet on the number 7 may be paid at 34 to 1, but a bet on the group 1-12 may be paid at 2 to 1. Typically, players may place an unlimited number of such bets, each bet evaluated independently of other bets, and, if appropriate, paid.

Money wheel (sometimes referred: o as the “Big 6”) is another popular casino multi-outcome/multi-bet game. The game consists of a vertically aligned wheel sectioned off into equal sized sectors, each said sector associated with a certain reward amount. Pegs at the edge of the wheel engage a flipper or marker that indicates which sector is the selected one. In an electronic or video game format, lights or highlighting can be used to designate the selected sector. Typically, the probability associated with a lower reward, i.e. the number of sectors associated with such a lower reward, or the programmed likelihood of its occurrence, is higher than the probability associated with a higher reward.

A play is initiated once players have placed one or more bets, by having a sector randomly selected. For a mechanical wheel, this is done by spinning the wheel and determining which sector the flipper denotes. For an electronic or video game version using lights or highlighting, the final sector is often selected by chase-light sequence whereby sectors are lit sequentially until the sequence stops and the final sector lit is designated as the sector selected.

A choice of potential bets are offered for the different outcomes whereby the player will be rewarded if he correctly predicts the reward amount associated with the wheel sector selected. For example, the player can bet that a sector featuring a $1 reward will be selected, or he can bet that the sector featuring a $5 reward, and so forth. Typically, the player is allowed make a number of simultaneous bets.

Another example of a multi-outcome/multi-bet game is a simulated racing game. Such a game uses a multiplicity of avatars engaging in a race, often depicted as horses or other animals or ships, cars, or other vehicles. The player may then bet on the relative finishing position of one or more of the avatars. For example, one electromechanical implementation of this game allows a player to bet on which one of 6 plastic horses will cross the finish line first in a simulated race. One video game implementation permits players to bet on which of 8 turtle characters will cross the finish line first in a simulated race. Often, such games the likelihood that a given avatar will finish first will vary by avator. The reward associated with each avatar varies accordingly.

Yet another multi-outcome/multi-bet game is a dice sum game such as Craps or Sic Bo. Certain sums are more like to occur than other sums. For example, there is only way to roll a sum of 12 with two dice (6+6), but there are six ways to roll a sum of 7 (6+1, 5+2, 4+3, 3+4, 2+5, 1+6). Such a game can be offered such that multiple simultaneous bets are possible.

Such multi-outcome/multi-bet games typically do not include a bonus reward component. As other categories of games have benefited from the popularity of such innovations, so too may these, and other, multi-outcome/multi-bet games.

### SUMMARY

This invention involves adding a bonus structure to multi-outcome/multi-bet casino games which pays against the bets made on the underlying game. Such bonus events can be triggered by a standard outcome of the underlying game upon which the player can bet, or an additional outcome of the underlying game upon which the player cannot bet, or by an event independent of the underlying game This invention further involves adding a bonus structure to multi-outcome/multi-bet casino games by designating certain rounds as bonus rounds with special rules and/or pay opportunities for wagers placed in the underlying game of chance.

In one optional embodiment, the bonus mechanism is initiated on a random basis by a randomizing technique such as the random selection of a special bonus ball or other such method. This can be accomplished by utilizing balls of different colors, at least one of which is designated as a bonus triggering event, or by an external event such as spinning a wheel, drawing a card from a shuffled deck, etc. Alternatively, the bonus mechanism may be implicated as a result of a game outcome, with specified game outcomes being designated as bonus triggering events. In another alternative embodiment, the bonus mechanism might be implicated whenever a standard game wager, or a selected group of standard game wagers, exceeds a predefined minimum.

In an optional embodiment, a bonus round for such an improved game could involve multiple spins not requiring the placing of an additional wager, or an increase in the reward amounts for winning outcomes during that round. A bonus round could also invoke an independent proposition which could lead to a specific reward or to an increase in a normal game reward. For example, a spinner could randomly specify a multiplier effect for any reward won in the standard game or in the bonus round.

In another optional embodiment, when applied to the game of roulette, this invention could involve the addition of at least one bonus sector or canoe. If the ball lands in such a bonus canoe, this could constitute a bonus triggering event. In one optional embodiment, such an event might increase a bonus accumulator. When such bonus accumulator reaches a predefined threshold amount, a bonus round could be initiated. In an alternate embodiment, a bonus event could be directly initiated upon having the ball land in a bonus canoe.

In one optional embodiment, the bonus event could lead to a direct pay based upon total bets. In another optional embodiment, the bonus event could be a special bonus spin. In such an embodiment, the original wagers could stand and any payout for winning outcomes in the bonus spin could be larger than standard, e.g. double the standard amount. Alternatively, the original wagers could stand and the player get a multiplicity of bonus spins, e.g. two free bonus spins. In an alternate embodiment, rather than a reward of ‘n’ bonus spins, the reward might be a single round utilizing ‘n’ balls. In an alternate embodiment, this could include a provision that no two bonus balls could share the same canoe or alternatively that multiple bonus balls could share the same canoe.

In an optional embodiment, the outcome of a bonus round might be the bonus triggering outcome. In an optional embodiment, this could negate the prior bonus reward. Alternatively, this could lead to an additional bonus reward. In one such embodiment, this could lead to a bonus round utilizing altered pay characteristics. For example, such a compound bonus triggering event could lead to the selection of a random reward multiplier, said reward multiplier being applied to any bonus reward otherwise generated. In an alternate embodiment, the bonus outcomes could be disabled during the bonus round.

In an optional embodiment, a separate bonus wager may be offered. Such a wager may either be required to receive a bonus reward, or might increase such resulting bonus reward.

In an optional embodiment of this invention being applied to roulette, the probability of a bonus canoe being selected might have different odds of being selected than do standard canoes. In a mechanical device, this can be accomplished by having the bonus canoe be of a different size as the regular, canoes, altering the probability of the roulette ball coining to rest in a bonus canoe. For example, a roulette wheel with 38 regular canoes and 1 bonus canoe could have the bonus canoe twice the size of a standard canoe, thereby making it twice as likely of selection. For an electronic version of this invention, such differentiation of probability may be accomplished by such programming as is currently known in the art.

The above alternate implementations may be applied in similar ways to a money wheel type game. A bonus sector might be added to the wheel, as could secondary or bonus flippers or markers.

The present invention might also be applied to games of simulated racing. In such games, a bonus can be initiated by the final position of a specified avatar. For example, a bonus could be activated if the most favored avatar (the avatar with the highest probability of finishing first) finishes the simulated race last. Alternatively, a special bonus avatar might be utilized, on which no bets could be placed and whose sole purpose would be the triggering of a bonus outcome. Such alternatives might implicate a single avatar, or a multiplicity of avatars, and might involve finishing first, last, or at any other predesignated positions.

This invention may also be applied to a dice sum game, wherein certain outcomes can be specified as, bonus triggering outcomes. Bonus rewards may be of types previously. defined. Alternatively, the dice sum game may utilize alternate bonus reward mechanisms.

In one such mechanism, a bonus event can be initiated which determines bonus rewards based upon the cumulative total of the bonus triggering outcome and one or more subsequent game outcomes. Thus, if for example dice throws totaling 3 or 11 are specified as bonusing initiating outcomes, a player rolling an 11 in the underlying game would initiate a bonus reward. If, on his next roll such player were to roll a 12, this would be accumulated with the prior roll of 11 for a total of 23. As summation of multiple rolls allows totals exceeding that of an ordinary play of the game, special bonus rewards might be accorded on such higher totals only. Alternately the accumulation might be performed in a wrap around methodology, using “modular arithmetic” or its equivalent.

In one such implementation, a bonus mechanism game can be created where the cumulative totals are indicated along the edges of a square or rectangle. For example, the values 1 through 5 might be indicated along one edge of a square, 5 through 9 along the next edge, 9 through 13 along the next edge and 13,14, 15, 16, 1 along the last edge. Moving about this square on each bonus triggering or bonus roll causes such total to “wrap” whenever it exceeds 16. For example, using the previous example of a bonus roll of 12 following a bonus triggering roll of 11 yields a total of 23, but in a board configuration, this results in a value of 7. (Utilizing modular arithmetic notation, 12+11=7(16).) Therefore the cumulative value of 7 would be used for bonus reward determination.

In another alternative, such bonus reward mechanism might continue as long as designated bonus continuing outcomes are generated. For example, if a bonus roll is a double, two die of matching value, an additional bonus roll might be involved. Should the bonus reward resolution indicate a bonus reward following each bonus triggering roll and each bonus roll, this would cause a continue, and growing, bonus reward. Additionally, the bonus rewards so determined could be altered each time the bonus square is completed, i.e. each time the cumulative total exceeds 16 and is thereby modulated.

Additional features and advantages are described herein, and will be apparent from the following Detailed Description and the figures.

### BRIEF DESCRIPTION OF THE FIGURES

FIG. 1 is a top view of a roulette inside bet area;

FIG. 2 is a top view of a roulette inside bet area with separate bonus bet area according to an embodiment of the present invention;

FIG. 3 is a top view of a roulette inside bet area with bonus bet area integrated at top according to an embodiment of the present invention;

FIG. 4 is a top view of a roulette inside bet area with bonus bet area integrated according to an embodiment of the present invention;

FIG. 5 is a traditional dice sum game;

FIG. 6 is a top view of a dice sum game with bonus outcomes according to an embodiment of the present invention;

FIG. 7 is a top view of a dice sum game with rethrow and wrap around features according to an embodiment of the present invention;

FIG. 8 is a top view of a dice sum game with rethrow and wrap around and bonus square features according to an embodiment of the present invention;

FIG. 9 is a dice sum game with rethrow and wrap around and bonus squares and combination bet features according to an embodiment of the present invention;

FIG. 10 is a flow diagram of a method with a bonus round selected before outcome according to an embodiment of the present invention;

FIG. 11 is a flow diagram of example game with bonus outcomes according to an embodiment of the present invention;

FIG. 12 is a flow diagram of bonus round with one replay at higher reward schedule according to an embodiment of the present invention;

FIG. 13 is a flow diagram of bonus round with multiple sequential replays according to an embodiment of the present invention;

FIG. 14 is a flow diagram of bonus round with multiple parallel replays according to an embodiment of the present invention;

FIG. 15 is a flow diagram of possible dice sum game with a bonus according to an embodiment of the present invention.

### DETAILED DESCRIPTION

Reference is now made to the figures wherein like parts are referred to by like numerals throughout. Throughout the optional embodiments illustrated herein, it is contemplated that the term “bonus rewards” are determined based upon wagers placed the underlying game. Furthermore, bonus rounds may be of fixed duration, or may be of a length as determined by outcomes generated during the execution of the bonus rounds, said results extending or curtailing the bonus generation as indicated according to the prespecified rules of play.

For purposes of illustration, bonus triggering and bonus extending outcomes are predefined per prespecified rules of play. In alternate embodiments, such bonus triggering and bonus extending outcomes may be randomly, and dynamically, defined.

Figure Illustrates the traditional roulette inside wagering area 100 including sample wagers 121, 122, 123. All game outcomes comprising the standard roulette wheel are represented within this inside wagering area 100. Wagers 121, 122, 123 may be placed which will be rewarded on the occurrence of one or more of these standard game results. The $1 wager 121 will be rewarded should either of two game outcomes, “6” 110 or “9” 111, occur. The $2 wager 0.122 will be rewarded only should the outcome “12” 112 occur. The $3 wager 123 will be rewarded if any one of three outcomes, “34” 113, “35” 114 or “36” 115, occur.

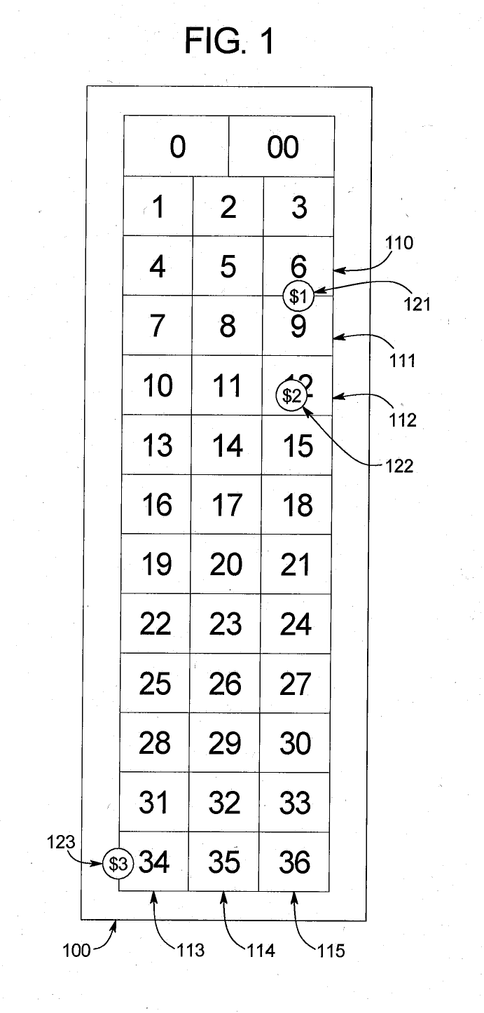

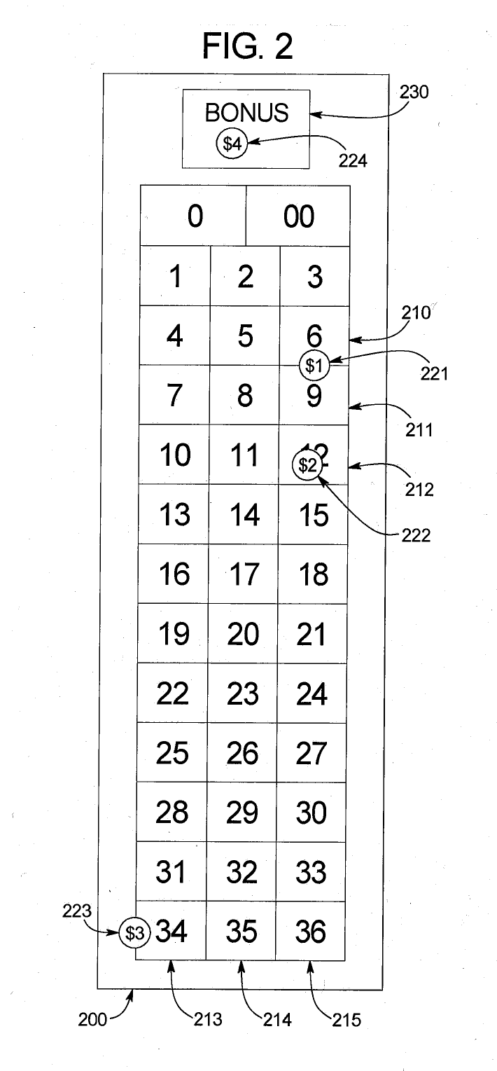

FIG. 2 depicts an alternate embodiment of a roulette inside wagering area 200 which has added a bonus wagering location 230. A sample $4 bonus wager 224 is illustrated, betting solely on such a bonus outcome. Non-bonus wagers made in this game 221, 222, 223, are nonetheless eligible for bonus rewards as determined in the bonus event whether or not a bonus wager 224 has been placed. In fact, in an alternate embodiment of this game, such a bonus wager 230 need not be available, and the inside wagering area 200 for such bonus-enhanced games may be indistinguishable from the inside wagering area 100 for the standard game as shown in FIG. 1.

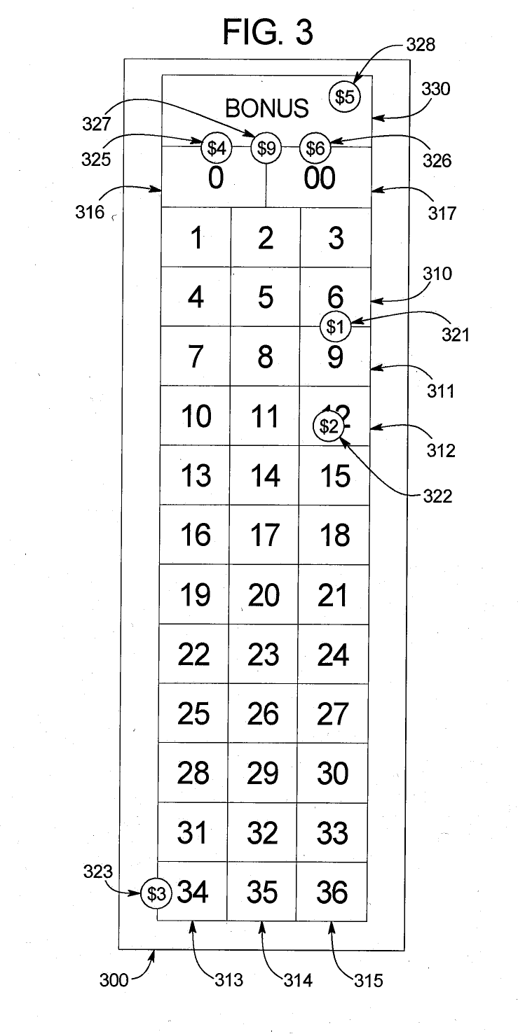

FIG. 3 depicts an alternate embodiment of a roulette inside wagering area 300 wherein the bonus wagering opportunity 330 has been integrated into the standard wagering design. In addition to such bonus wagers as previously described 328, this embodiment facilitates wagers on combinations of game and bonus outcomes 325, 326. and 327. The $4 sample wager 325 is rewarded should either a bonus outcome 330 occur or should a “0” 316 occur. This effectively places a $2 wager on a bonus outcome 330 and a $2 wager on the “0” outcome 316. The $6 sample wager 326 is rewarded should either a bonus outcome 330 occur or should a “00” 317 occur. This effectively places a $3 wager on a bonus outcome 330 and a $3 wager on the “00” outcome 317. The $9 sample wager 326 is rewarded should bonus outcome 330 occur, should a “0” 316 occur, or should a “00” 317 occur. This effectively places a $3 wager on a bonus outcome 339, a $3 wager on the “0” outcome 316, and a $3 wager on the “00” outcome 317. For purpose of illustrations, amounts wagered were varied for descriptive clarity, but in an actual game, all of the wagers can typically be of the same amount.

In general, wagers on combinations of numbers offer two advantages: 1) they allow a player to have some control balancing risk and reward, wherein a wager on a larger set of potential winning outcomes increases the probability of obtaining such a winning outcome, but reduces the ratio of the reward of such a winning outcome to the amount wagered, and 2) combination wagers simplify the practice of placing multiple wagers, in particular where the size of the combination wager is large enough to approximate the sum of the equivalent individual wagers. For example, the $3 combination wager 323 for outcomes “34” 313, “35” 314 and “36” 315 could be made as three separate $1 wagers, one on each of the indicated outcomes, should $1 wagers be permitted, but placing a single combination wager 323 requires less effort, on the part of the player as well as on the house. Furthermore, if the minimum wager. is $1, the player could make a $1 wager on the combination “34” 313, “35” 314 and “36” 315 even where a wager of $⅓ for each such outcome would not be permitted.

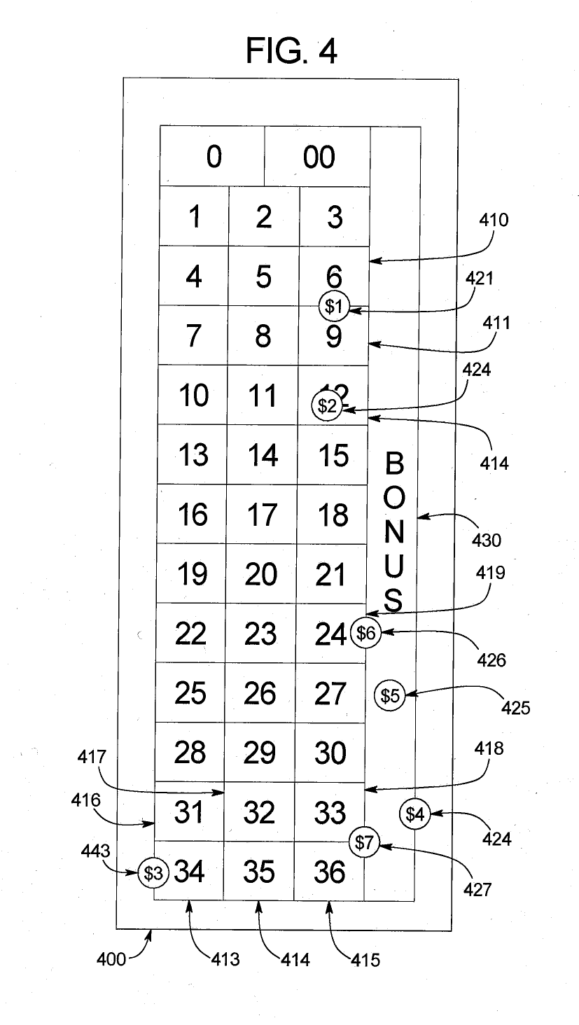

FIG. 4 depicts a roulette inside wagering area 400 with an alternate embodiment of the integration of the bonus wagering location 430. In this embodiment, the bonus wagering location 430 is appended to one of the long sides of the standard inside wagering area 400. In addition to direct bonus wagers 425, this configuration also allows extensive combination wagers which combinations of game. and bonus outcomes 424, 426 and 427. The $6 sample wager 426 is rewarded should a bonus outcome 430 occur or should a “24” 419 occur. This effectively places a $3 wager on a bonus outcome 430 and a $3 wager on the “24” outcome 419. The $4 sample wager 424 is rewarded should a bonus outcome 430 occur, should a “31” 416 occur, should a “32” 417 occur or should a “33” 418 occur. This effectively places a $1 wager on a bonus outcome 430, a $1 wager on an outcome of a “31” 416, a $1 wager on an outcome of a “32” 417, and a $1 wager on an outcome of a “33” 418. The $7 sample wager 427 is rewarded should a bonus outcome 430 occur, should a “31” 416 occur, should a “32” 4.17 occur, should a “33” 418 occur, should a “34” 413 occur, should a “35” 414 occur, or should a “36” 415 occur. This effectively places a $1 wager on a bonus outcome 430 and a $1 wager on each of the outcomes “31”, “32”, “33”, “34”, “35” and “36” 413-418. This embodiment still allows game wagers across three numbers such as the sample wager $3 443 on the combination of outcomes “34” 413, “35” 414 and “36” 415 without requiring this combination to also include the bonus outcome.

While not illustrated in the embodiments illustrated, alternate embodiments include configurations wherein combination wagers are available which incorporate bonus wagers with other game wagers, such as the game outside wagers (RED, BLACK, HIGH, LOW, EVEN, ODD, 1st DOZEN, 2nd DOZEN, 3rd DOZEN, 1st COLUMN, 2nd COLUMN, 3rd COLUMN).

While the payouts could take any form and are not restricted to any specific form or quantity, Table 1 illustrates an example pay table for a roulette game according to the embodiment of FIGS. 2-4.

TABLE 1
Inside Bets

| | |
|---|---|
| Straight Bets | 35 to 1 |
| Split Bet | 17 to 1 |
| Trio Bet | 11 to 1 |
| Corner Bet | 8 to 1 |
| Five-number Bet | 6 to 1 |
| Six-number Bet | 5 to 1 |

Outside Bets

| | |
|---|---|
| Dozens | 2 to 1 |
| Column | 2 to 1 |
| Even-odd | 1 to 1 |
| Red-black | 1 to 1 |
| High-low | 1 to 1 |

If Standard Ball Lands on Yellow, All Bets Stand and Double Ball Bonus Round Commences.

Yellow Bonus Bets

| | Standard Ball | 1 Bonus Ball | Both Bonus Balls |
|---|---|---|---|
| | on Yellow | on Yellow | on. Yellow |
| Straight Yellow Bet | 12 × Bonus Bet | 120 to 1 | 1200 to 1 |
| Split Yellow Bet | 6 × Bonus Bet | 60 to 1 | 600 to 1 |
| Trio Yellow Bet | 4 × Bonus Bet | 40 to 1 | 400 to 1 |

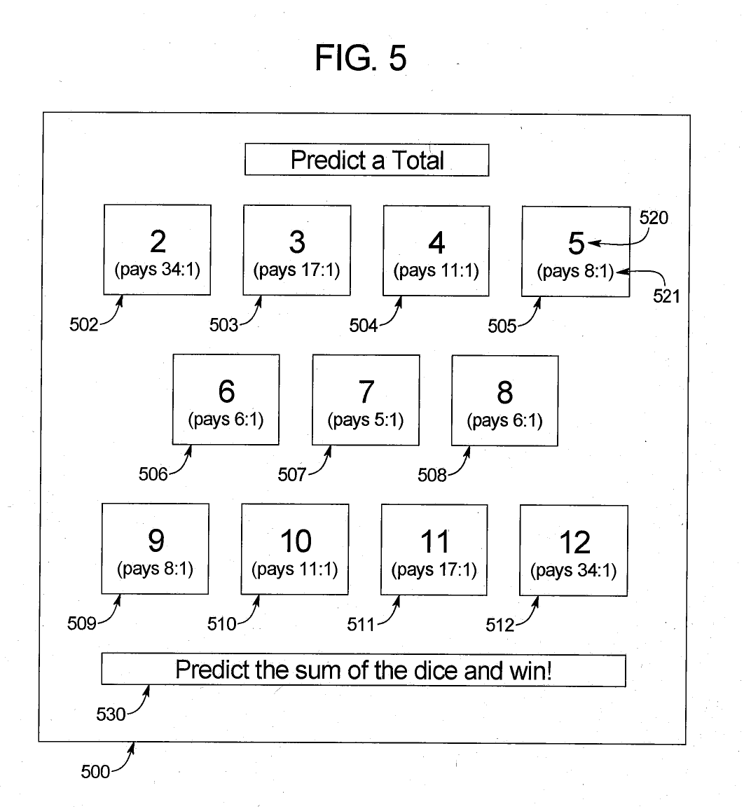

FIG. 5 depicts an optional embodiment for a traditional dice sum game 500. In this embodiment, the player may place a wager on any of the wagering areas 502 through 512 and as indicated in the instructions 530, and is rewarded if an outcome on which he has wagered results occurs on the next throw of two standard dice. Referring to the wagering area for the outcome “5” 505 as an example, the wagering area lists the outcome being wagered upon 520 and the reward ratio to be paid on such a wager should that outcome 520 occur.

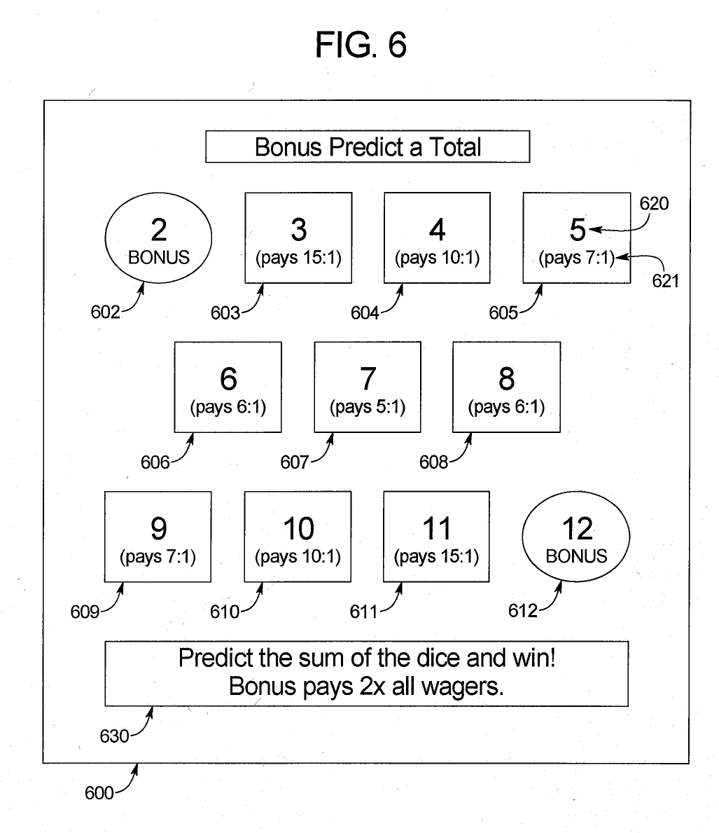

FIG. 6 illustrates an alternate embodiment 600 of the present invention to that depicted in FIG. 5 500. Two of the outcomes, “2” 602 and “12” 612 are designated as bonus outcomes. In this embodiment, as indicated in the instructions 630, if the outcome of the next throw of two standard dice yields a sum of 2 602 or a sum of 12 612, then player will win twice the total amount wagered in the current play of the game. For example, if the player has wagered $2 on the outcome “6” 606, and $3 on the outcome “8” 608, and the next outcome has a sum of 12, then the player will be paid twice his total wager or $10.

It should be noted that, in this embodiment, the bonus feature increases the expected payback to the player. In order to compensate for such a variation, and still be able to continue to offer this game at a profit, the house may have reduced some of the game rewards. For example, the reward ratio for the outcome “5” 605 has been reduced from 8 to 1 521 in an embodiment corresponding to FIG. 5, to 7 to 1 621 for an embodiment corresponding to FIG. 6. In one optional implementation of this embodiment, players need not place a bonus wager in order to receive a bonus reward. In an alternate implementation of this embodiment, a bonus wager may be a condition precedent for receipt of, or participation in, a bonus reward.

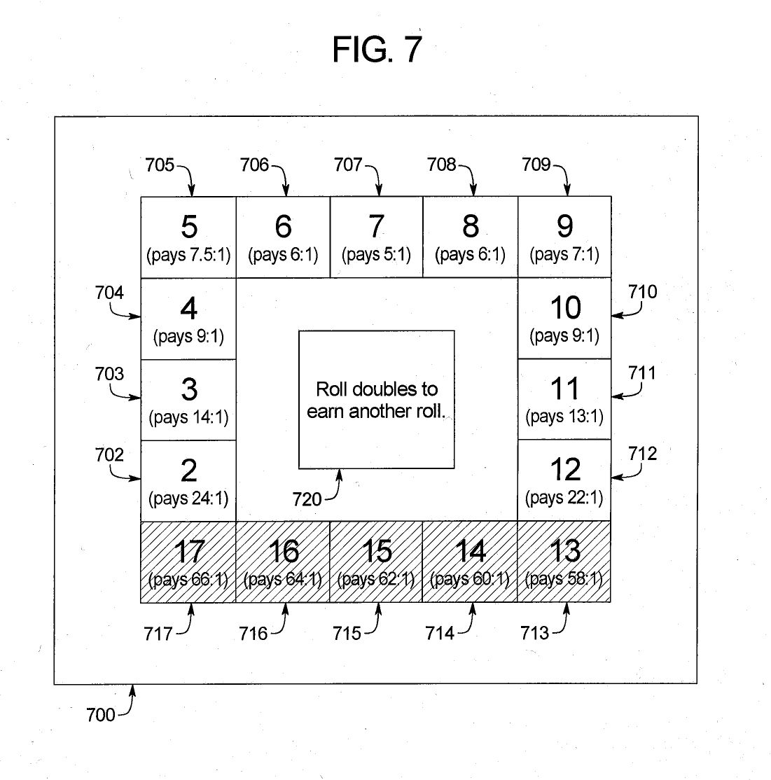

FIG. 7 illustrates an alternate embodiment of the present invention applied to a dice sum game 700 where the bonus reward is the opportunity to obtain additional reward opportunities should a bonus triggering outcome be generated. In the optional embodiment illustrated, the throwing of “doubles,” i.e. where the value on both dice are equal, in other words combinations of 1,1 or 2,2 or 3,3 or 4,4 or 5,5 or 6,6, constitutes such a bonus triggering outcome. In alternative embodiments, other outcomes may be used. The player may wager on any of the outcomes 702 through 717. While outcomes “2” through “12” 702-712 can all be attained in a single role of the dice, outcomes “13” through “17” 713-717 can only be attained by rolling a bonus a double, and then adding the sum of the additional roll awarded. For example, should a player wager on outcome “6” 706 and double 3's were thrown, the player would win 6:1 on his “6” wager 706. However, as a bonus triggering outcome had been thrown, play continues with all wagers standing, independent of wagers placed on “6” 706. Whatever sum is next thrown will be added to the sum of the dice comprising the bonus triggering outcome to generate a new dice sum. For example, if the second roll yields a sum of 10, then the resulting outcome is 10 beyond the current sum or 6+10=16. If the player has a wager on “16” 716, such a player will be rewarded at a payoff of 64:1. Furthermore, if the player's 2nd roll was a 12, then the resulting outcome would be 12 beyond the current 6, which, as this layout utilizes an equivalent of modulo 16 arithmetic, would yield an outcome of 2. In addition, as, in the optional embodiment illustrated, a roll of 12 is double, and hence a bonus extending outcome, the player gets another roll of the dice, with all wagers still standing, with the starting sum now equal to 2. In an optional implementation of this embodiment, a special bonus could be rewarded to all players any time the bonus sum exceeds 17, i.e. “wraps around.” For example, any reward paid after having gone around the board once could result in the reward amount being twice as large as normal.

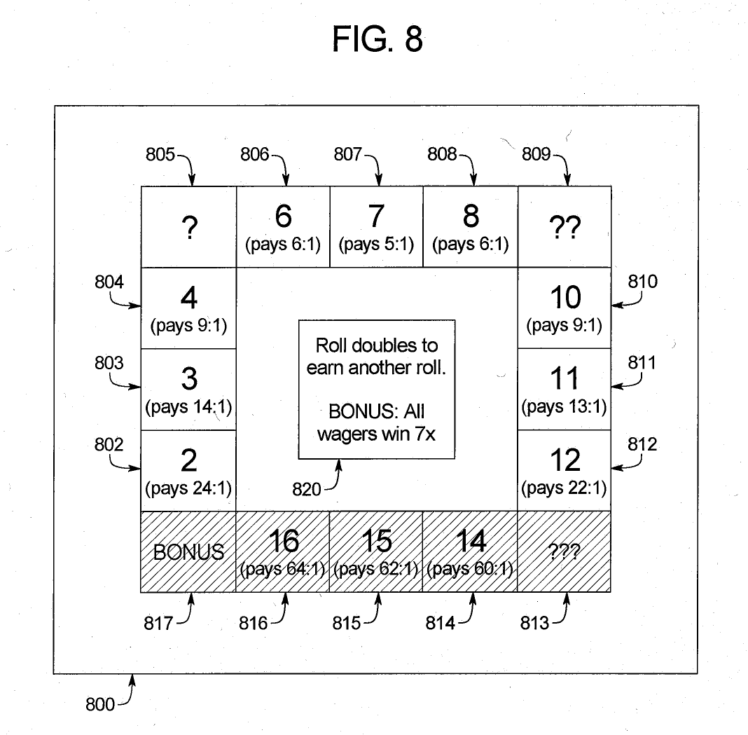

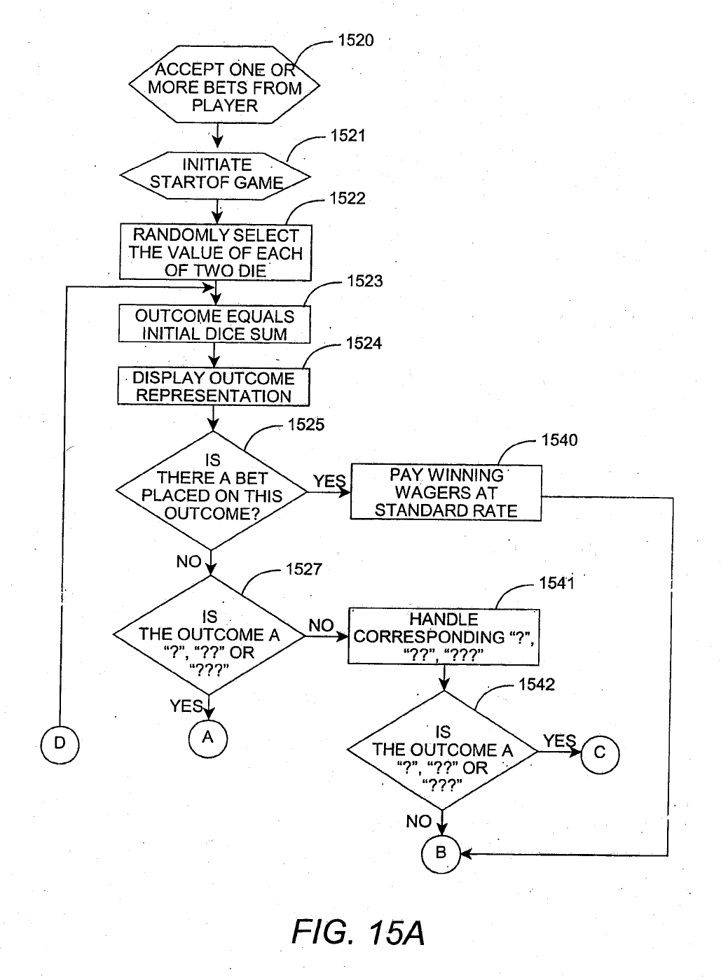

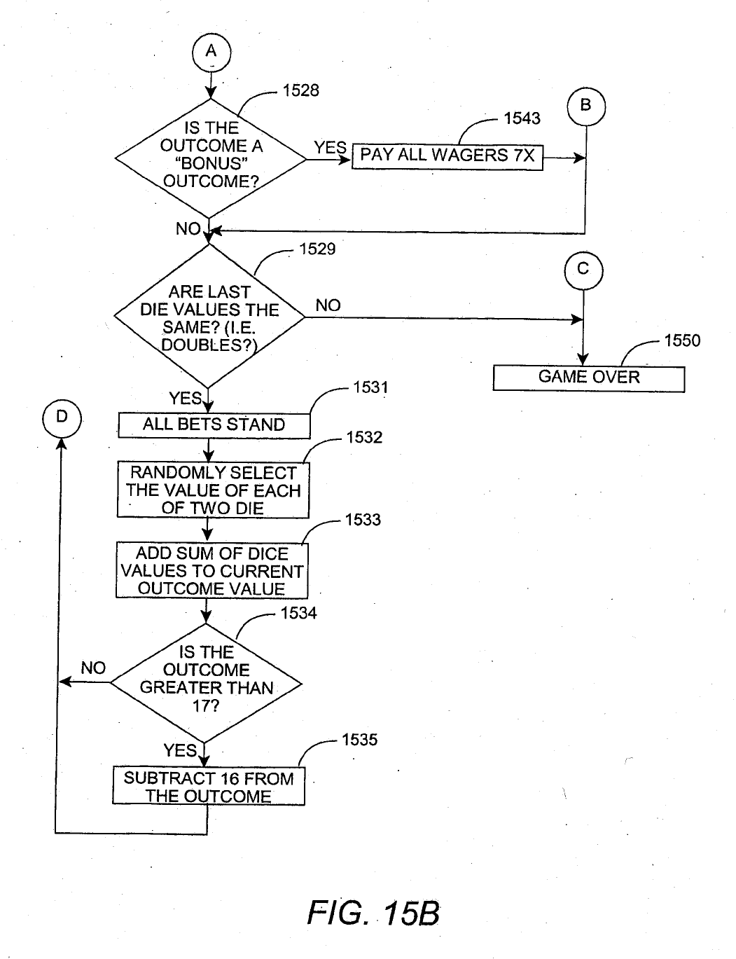

FIG. 8 depicts an alternate embodiment 800 of the game previously depicted in FIG. 7 700 where, in the present embodiment, selected outcomes 805, 809, 813, 817 have been designated to receive bonus outcomes. The bonus “?” 805 arises for an outcome of 5, the bonus “??” 809 arises for an outcome of 9, and the bonus “???” 813 arises for an outcome of 13. In the optional implementation illustrated, the “?” bonus, the “??” bonus, and the “???” bonus each result in an. effect determined at random. Such effects may be accorded as a random relocation to another outcome spot on the board, the ability to throw the dice again from that spot, the granting of a static reward, the granting of a random reward from a series of possible rewards, or even the ending of the game with no reward issued. The potential outcomes, as well as the probabilities of random selection of such potential reward may optionally vary for each such bonus outcome. This game 800 also features a BONUS spot 817 which, as indicated by the game instructions, will result in a reward being paid which is equal to seven times the sum of all placed wagers. Flow logic for this game is presented in FIG. 15.

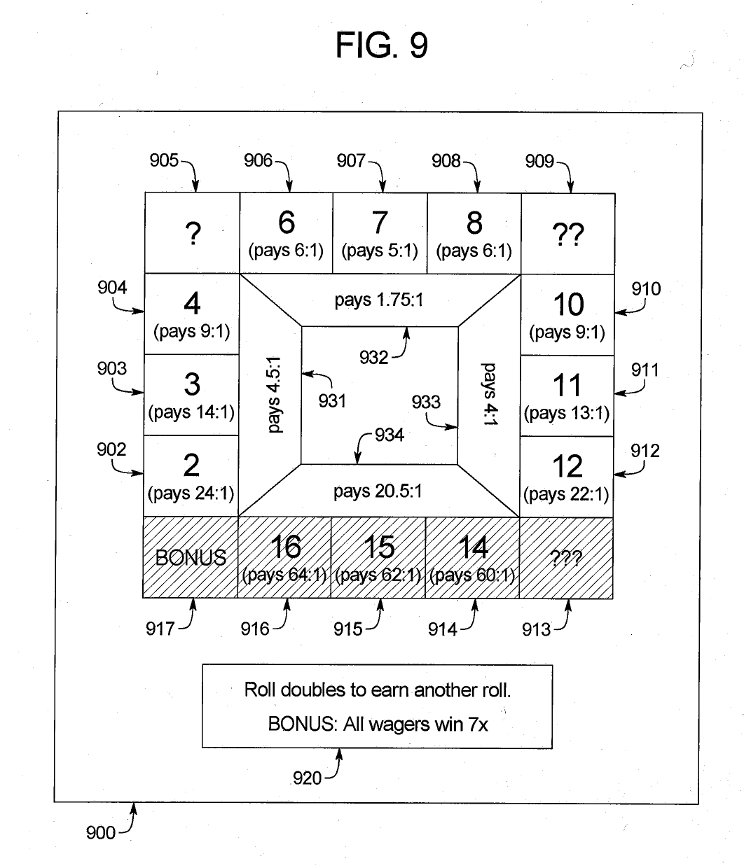

FIG. 9 depicts an optional embodiment 900 of the implementation of the present invention which permits of combination wagers on bonus sums. Specifically, there are a new wager opportunities 931 through 934 for combinations of outcomes. A wager on 931 is rewarded at 4.5:1 on an outcome of a “2”, “3” or “4.” A wager on 932 is rewarded at 1.75:1 for an outcome of “6”, “7” or “8,” and so forth.

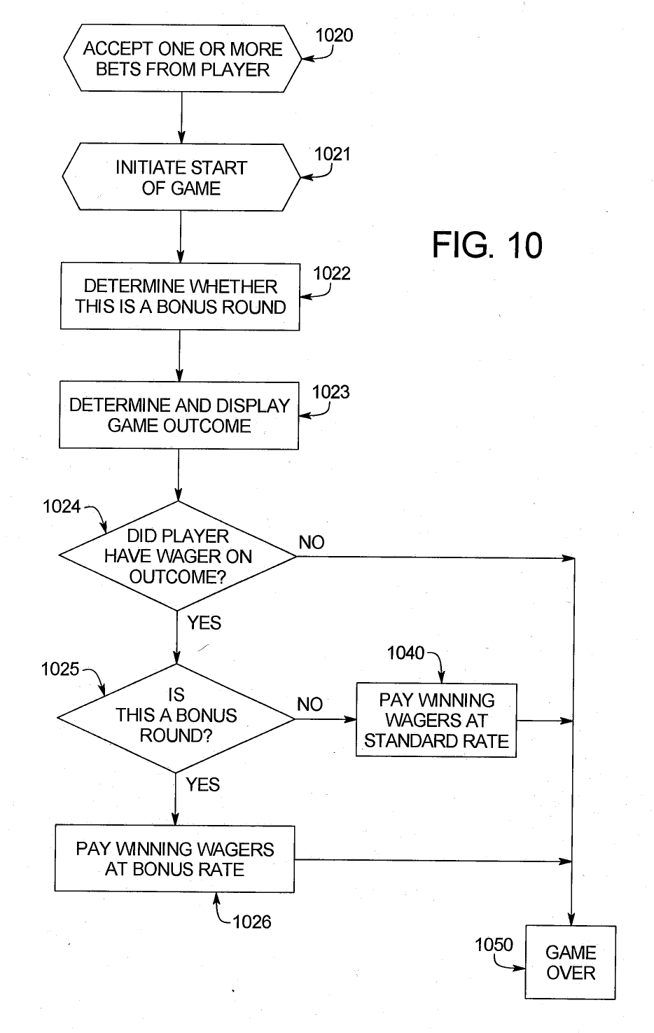

FIG. 10 shows a logic flow chart of one embodiment of this invention. The player places his wagers 1020 and starts the game 1021. Once the wagers are committed, we determine whether or not this is a bonus round. For one optional implementation of this invention as applied to a Roulette-based game, this could involve the random selection of the roulette ball where at least one designated ball, optionally identified by color, indicates a bonus round. For a Money Wheel-based game, this might optionally involve the random *ling of light colors, at least one of which colors being associated with a bonus round. Alternately, this could involve other selectors such as a secondary spinning wheel, dice or other indicia. The standard game is played out 1023 and an outcome determined. If this outcome was not predicted and wager upon by the player 1024 then the game is over 1050: if the outcome does match a placed wager, then the actual reward is determined based on whether or not this is a bonus round 1025. If it is not a bonus round, then winning outcomes are paid at the standard rate 1040 and the game ends 1050. If it is a bonus round, then the winning outcomes are paid at the higher bonus rate 1026 before the game ends 1050.

Though not shown in this figure, it would also be possible to support different bonus reward structures based upon the bonus selection. For example, in a Roulette-based game, the silver ball could indicate a standard pay while a blue ball indicates a 2× pay and a yellow ball indicates a 3× pay.

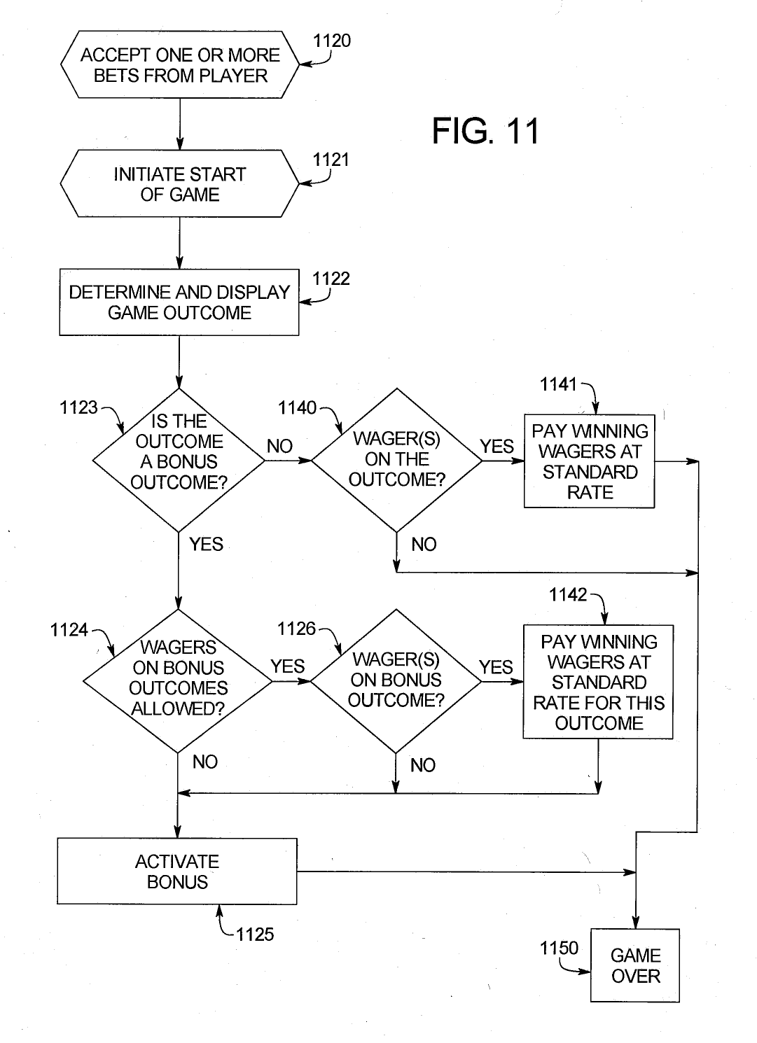

FIG. 11 illustrates the flow chart of an alternate embodiment of this invention. The player places his wagers 1120, the game is started 1121 and the game outcome is determined 1122. If the outcome is not a bonus outcome 1123, then game reward evaluation is performed 1140 to determine whether a game reward should be paid 1141. If this outcome is a bonus outcome, and if the game is defined to allow wagers to be placed on a bonus outcome 1124 and if one or more wagers were made on the bonus outcome 1126 then a reward is paid against said wagers 1142 game. Irrespective of whether or not bonus outcomes are enabled or whether or not bonus outcome wagers were paid and placed, the bonus outcome activates a bonus round 1125.

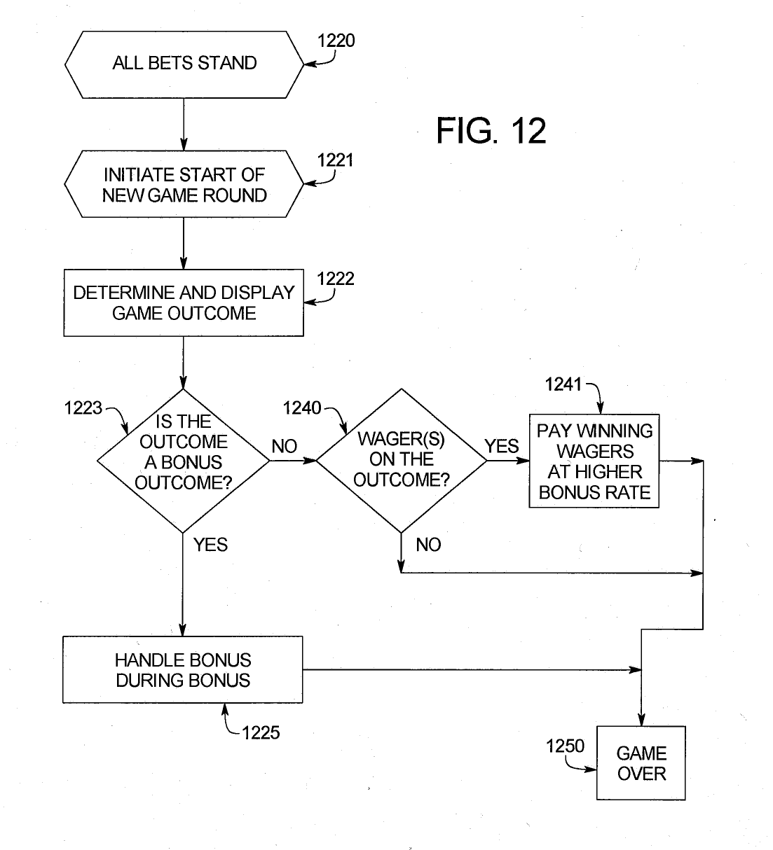

FIG. 12 depicts the flow chart of yet another embodiment of this invention, illustrating one possible bonus outcome activation. All wagers from the original game stand 1220 and another game round is played out 1221 and 1222. If the outcome is not the bonus again 1223, the outcome is compared against the placed wagers 1240 and winnings are paid against such correctly matching wagers 1241, but an adjusted reward rate, typically higher than the normal. An example of such would be to pay out twice as much as usual in the bonus round vs. in a standard round.

A bonus triggering outcome achieved during a bonus round is resolved according to prespecified game rules 1225. This may optionally include activating an additional bonus round at the same reward levels, or activating another bonus round at a modified reward schedule. In one such implementation, this could cause all rewards to be tripled, rather than doubled.

In another such implementation, this could cause all wagers not placed on the bonus outcome to lose. Where the game permits players to place wagers directly on a bonus outcome, then another bonus outcome during a bonus round could lead to special rewards for such bonus wagers.

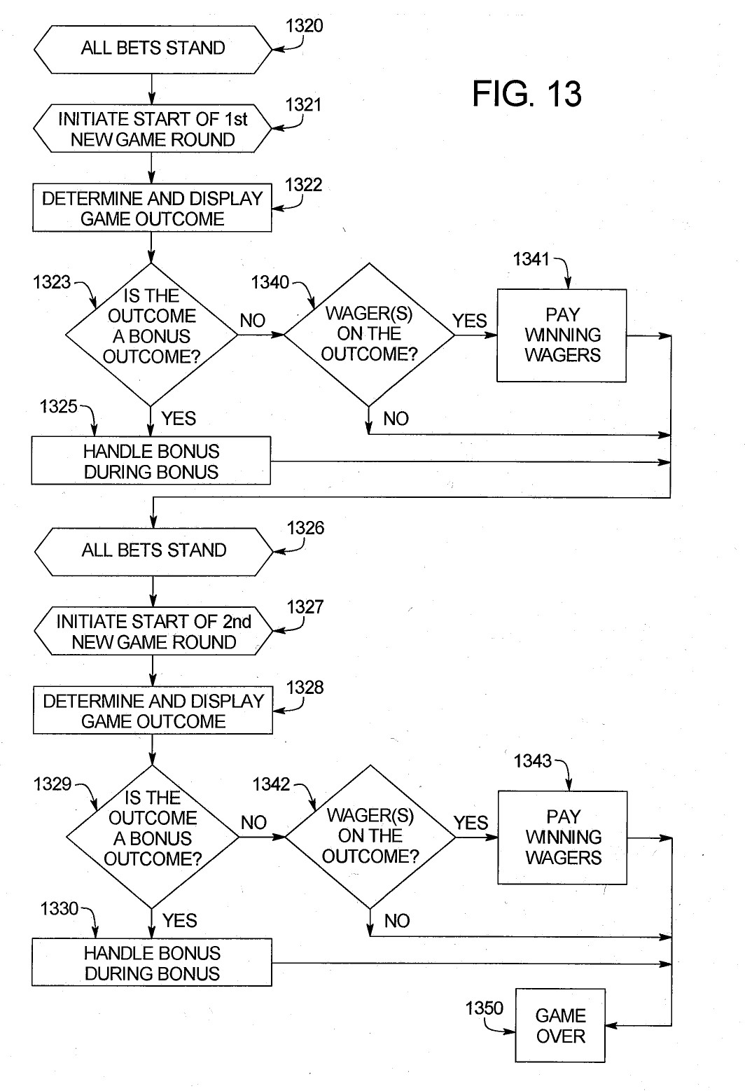

FIG. 13 portrays yet another flow chart of an alternate implementation of this invention, in particular showing one possible bonus outcome activation. In this implementation, all wagers from the original game stand 1320 and the first of at least two game rounds is played out 1321, 1322. If the outcome is not the bonus again 1323, the outcome is compared against the placed wagers 1340 and rewards are paid against such correctly matching wagers 1341. Such rewards could be played out at standard rates or alternatively at special bonus round rates. If the outcome is a bonus outcome, then it can be handled as discussed above. Once the first bonus round is played out, a second bonus round is likewise played out with all wagers from the original game continuing to stand 1326, another round being played out 1327 and 1328 and the results evaluated and acted upon 1329, 1342, 1342, 1330. Clearly, this concept can be easily extended to allow any plurality of bonus rounds to be played out.

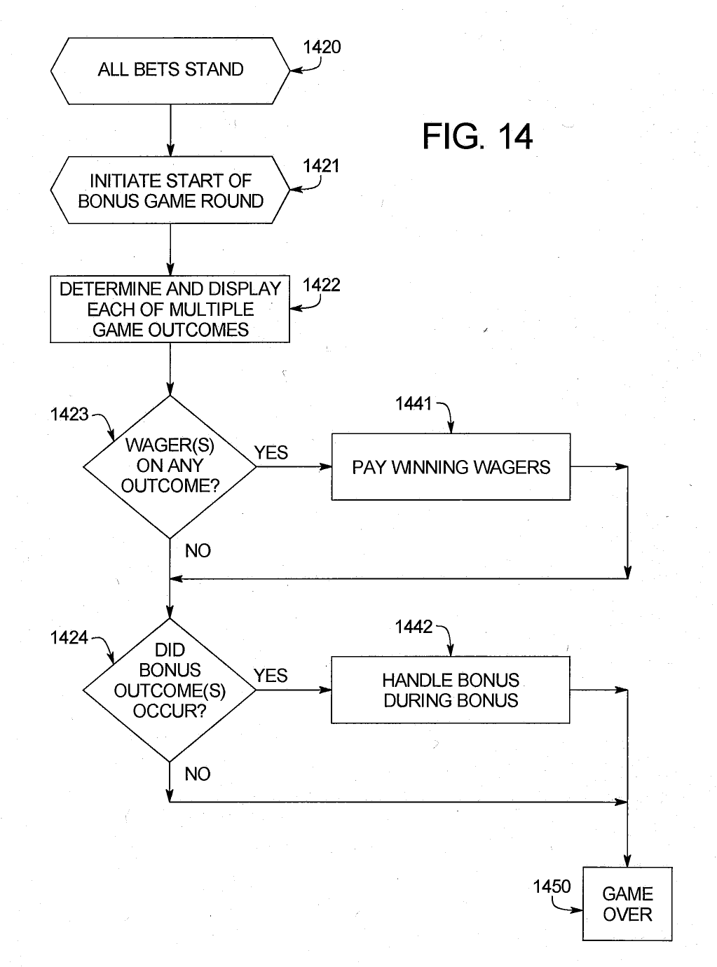

FIG. 14 illustrates an alternate flow chart of another bonus outcome activation. This implementation is similar to that depicted in FIG. 13, except that the multiple bonus round outcome are determined in parallel instead of sequentially. All wagers from the original game stand 1420 and the game rounds is played out 1421 where multiple outcomes are generated 1422. Optionally, these outcomes may be mutually exclusive or completely independent of each other. Each outcome is compared against wagers placed 1423, and winnings paid against such matching wagers 1441. Such rewards may optionally be paid at standard rates or at special bonus round rates according to predefined game definition. If the outcome is a bonus outcome, then it can be handled as discussed in FIG. 13 above.

FIG. 15 illustrates a flow chart for the optional embodiment previously shown in FIG. 8. The player places his wagers 1520 and the game commences 1521. The value for each of two dice is determined 1522 by the throw of physical dice or by the random generation of values which appear on electro-mechanical or video dice simulations. The initial outcome is determined by computing the sum of the two dice values 1523 and this outcome is then displayed 1524. When applied to a game such as that depicted in FIG. 8, the location on the game board corresponding to the generated outcome can be marked or highlighted. Any wager placed on the current outcome 1525 is rewarded in accordance with the predefined pay schedule 1540. Outcomes of “?”, “??,” or “???” 1527 initiate the rewarding of a bonus effect 1541. The bonus effect to be rewarded may be the earning of another thrown, the payment of a reward, the random relocation to a new outcome location, the ending of the game irrespective of whether a bonus triggering outcome were generated, or other such rewards as determined by random generation from a predetermined list of potention rewards.

If the bonus effect is to end the game 1542, then the game ends 1550, else we proceed to consider whether a bonus triggering outcome has been created. In the optional embodiment illustrated, such outcomes comprise the throwing of doubles 1529, but in alternative implementations, other outcomes-could be used. If the outcome was a “BONUS” outcome 1528 then a reward is paid, said reward being optionally computed based on all outstanding wagers 1543. Whether a bonus is paid or not, we proceed to consider whether a bonus extending outcome has been created. Optionally such an outcome is comprised of a throw of doubles. In the optional embodiment illustrated, players may not place wagers on “?”, “??,” “???” or “BONUS” but in an alternate embodiment such wagers may be permitted.

Once the current outcome has been evaluated, we look at whether the last dice throw was a bonus extending outcome, which in the optional embodiment illustrated consists of a throw of “doubles” 1529, i.e. whether the die values of the thrown dice are equal. If not, then the game ends 1550. Else if doubles were thrown, the player receives another throw of the dice for which all of his current wagers stand 1531, and the player will again be eligible for winnings based upon the generated outcome. As described previously 1522, two dice values are generated and summed to determine the current throw total, which total is then to the outcome sum of prior throws within the current bonus round 1533 to form the new outcome sum where such computation is performed in a modular arithmetic manner to generate a sum, modulo 16, where the sum of 0 is depicted as a value of 16, and the sum of 1 is depicted as a value of 17 1535. Once a new outcome has been determined, processing loops back to start another round of outcome evaluation 1524. In this sample game, there is no limit on how many bonus throws may occur within a single game. In an alternate implementation, such a limit may be designated.

In an optional embodiment illustrated, player bonus rewards are paid after each bonus triggering event and bonus outcome. In an alternate embodiment, player bonus rewards could be paid only at predesignated points within the bonus round, for example, after every m rolls, or only at the end of the bonus round.

While certain embodiments of the present invention have been shown and described it is to be understood that the present invention is subject to many modifications and changes without departing from the spirit and scope of the claims presented herein.

The invention is claimed as follows:

1. A gaming system comprising:
at least one display device;
at least one input device;
at least one processor; and
at least one memory device which stores a plurality of instructions, which when executed by the at least one processor, cause the at least one processor to operate with the at least one display device and the at least one input device to:
(a) display a plurality of wager areas;
(b) display a plurality of different wager area values, each one of the wager area values being associated with one of the wager areas;
(c) display a plurality of different reward ratios, each one of the reward ratios being associated with one of the wager areas;
(d) display at least one bonus area;
(e) display a bonus area value in association with the bonus area, the bonus area value being different from the wager area values;
(f) receive a wager input associated with a wager;
(g) receive a selection input associated with a selection of at least one of the wager areas, the wager being applied to the at least one selected wager area;
(h) display a simulated rolling of a plurality of dice, each one of the dice having a plurality of sides, each one of the sides displaying at least one symbol, each symbol indicating a die value, at least two of the die values being different;
(i) stop the display of the simulated rolling of the dice;
(j) display one of the sides of each one of the dice;
(k) calculate a sum of the die values of the displayed sides;
(l) provide a game award as a result of the sum being equal to the wager area value of the at least one selected wager area; and
(m) provide a bonus outcome as a result of the sum being equal to the bonus area value.

2. The gaming system of claim 1, wherein the at least one memory device stores a plurality of instructions, which when executed by the at least one processor, cause the at least one processor to operate with the at least one display device and the at least one input device to: (a) display at least one additional bonus area; (b) display an additional bonus area value in association with the additional bonus area, the additional bonus area value being different from the wager area values; and (c) provide a bonus outcome as a result of the sum being equal to the additional bonus area value.

3. The gaming system of claim 1, wherein: (a) the wager areas include a quantity of eleven wager areas; (b) the wager area values include two, three, four, five, six, seven, eight, nine, ten, eleven, and twelve.

4. The gaming system of claim 1, wherein the bonus outcome is a product of a factor and the wager, the factor being greater than one.

5. The gaming system of claim 1, wherein the bonus outcome includes a bonus award.

6. The gaming system of claim 1, wherein the bonus outcome includes a repeat of steps (g) through (l) without requiring an additional wager.

7. The gaming system of claim 1, wherein the game award is determined based upon the reward ratio of the selected wager area.

8. A gaming system comprising:
at least one display device;
at least one input device;
at least one processor; and
at least one memory device which stores a plurality of instructions, which when executed by the at least one processor, cause the at least one processor to operate with the at least one display device and the at least one input device to:
(a) display a path having a plurality of wager areas connected together to define a cycle;
(b) display a plurality of different wager area values, each one of the wager area values being associated with one of the wagers;
(c) display a plurality of different reward ratios, each one of the reward ratios being associated with one of the wager areas;
(d) receive a wager input associated with a wager;
(e) receive a selection input associated with a selection of at least one of the wager areas, the wager being applied to the at least one selected wager area;
(f) display a simulated rolling of a plurality of dice, each one of the dice having a plurality of sides, each one of the sides displaying at least one symbol, each symbol indicating a die value, at least two of the die values being different;
(g) stop the display of the simulated rolling of the dice;
(h) display one of the sides of each one of the stopped dice;
(i) calculate a sum of the die values of the displayed sides;
(j) provide a game award as a result of the stopped dice satisfying a game award condition, the game award condition requiring that the sum be equal to the wager area value of the at least one selected wager area; and
(k) provide a bonus outcome as a result of the die values of the displayed sides being identical.

9. The gaming system of claim 8, wherein: (a) the wager areas include a quantity of eleven wager areas; (b) the wager area values include two, three, four, five, six, seven, eight, nine, ten, eleven, and twelve.

10. The gaming system of claim 8, wherein the at least one memory device stores a plurality of instructions, which when executed by the at least one processor, cause the at least one processor to operate with the at least one display device and the at least one input device to determine a first position along the path, the first position being associated with the wager area which has a wager area value equal to the sum.

11. The gaming system of claim 10, wherein the bonus outcome includes a repeat of steps (f) through (i) without requiring an additional wager, the repeated steps resulting in a second sum.

12. The gaming system of claim 11, wherein the at least one memory device stores a plurality of instructions, which when executed by the at least one processor, cause the at least one processor to operate with the at least one display device and the at least one input device to determine a second position along the path, the second position being determined through advancement by a quantity of the wager areas relative to the first position, the quantity being equal to the second sum.

13. The gaming system of claim 12, wherein the path includes at least one bonus area, the bonus area displaying a bonus area value.

14. The gaming system of claim 13, wherein the at least one memory device stores a plurality of instructions, which when executed by the at least one processor, cause the at least one processor to operate with the at least one display device and the at least one input device to provide a second bonus outcome as a result of the second position having a same location as the bonus area.

15. The gaming system of claim 14, wherein the second bonus outcome includes a product of a factor and the wager, the factor being greater than one.

16. The gaming system of claim 15, wherein the bonus outcome includes a product of a factor and the wager, the factor being greater than one.

17. The gaming system of claim 15, wherein the bonus outcome includes a bonus award.

18. The gaming system of claim 15, wherein the game award is determined based upon the reward ratio of the selected wager area.

19. A gaming system comprising:
at least one display device;
at least one input device;
at least one processor; and
at least one memory device which stores a plurality of instructions, which when executed by the at least one processor, cause the at least one processor to operate with the at least one display device and the at least one input device to:
(a) display a path having a plurality of areas connected together to define a cycle, the areas including a plurality of wager areas and at least one bonus area;
(b) display a plurality of different wager area values, each one of the wager area values being associated with one of the wagers;
(c) display a plurality of different wager area reward ratios, each one of the wager area reward ratios being associated with one of the wager areas;
(d) display a bonus value associated with the bonus area;
(e) display a plurality of combination areas, the combination areas being associated different combinations of the wager areas;
(f) display a plurality of different combination reward ratios, each one of the combination reward ratios being associated with one of the combinations;
(g) receive a wager input associated with a wager;
(h) receive a selection input associated with a selection of at least one area selected from the group consisting of the wager areas and the combination areas, the wager being applied to the at least one selected area;
(i) display a simulated rolling of a plurality of dice, each one of the dice having a plurality of sides, each one of the sides displaying at least one symbol, each symbol indicating a die value, at least two of the die values being different;
(j) stop the display of the simulated rolling of the dice;
(k) display one of the sides of each one of the stopped dice;
(l) calculate a sum of the die values of the displayed sides;
(m) if the selected area is one of the wager areas, provide a game award as a result the sum be equal to the area value of said wager area; and
(n) if the selected area is one of the combination areas, provide a game award as a result of the sum being equal to one of the area values of the wager areas associated with said combination area.

20. The gaming system of claim 19, wherein: (a) the wager areas include a quantity of eleven wager areas; (b) the wager area values include two, three, four, five, six, seven, eight, nine, ten, eleven, and twelve.

21. The gaming system of claim 20, wherein the at least one memory device stores a plurality of instructions, which when executed by the at least one processor, cause the at least one processor to operate with the at least one display device and the at least one input device to determine a first position along the path, the first position being associated with the wager area which has a wager area value equal to the sum.

22. The gaming system of claim 21, wherein the bonus outcome includes a repeat of steps (i) through (n) without requiring an additional wager, the repeated steps resulting in a second sum.

23. The gaming system of claim 22, wherein the at least one memory device stores a plurality of instructions, which when executed by the at least one processor, cause the at least one processor to operate with the at least one display device and the at least one input device to determine a second position along the path, the second position being determined through advancement by a quantity of the wager areas relative to the first position, the quantity being equal to the second sum.

24. The gaming system of claim 23, wherein the at least one memory device stores a plurality of instructions, which when executed by the at least one processor, cause the at least one processor to operate with the at least one display device and the at least one input device to provide a bonus outcome as a result of the second position having a same location as the bonus area.
